(19) United States
(12) Patent Application Publication
(10) Pub. No.: US 2026/0296387 A1
(43) Pub. Date: Oct. 1, 2026

(54) VEHICLE BRAKE SYSTEM FOR FOUR WHEEL ELECTROMECHANICAL BRAKE (EMB) ARCHITECTURE

(71) Applicant: HL MANDO CORPORATION, Gyeonggi-do (KR)

(72) Inventors: Christian ROSS, Auburn, MI (US); Tomy SEBASTIAN, Auburn, MI (US); Raja RAMAKRISHNAN, Auburn, MI (US); Dheerajkumar PATEL, Auburn, MI (US); Lucas RITTER, Auburn, MI (US); Shakil HOSSAIN, Auburn, MI (US); Jonathan KNIEPER, Auburn, MI (US)

(21) Appl. No.: 19/547,406

(22) Filed: Feb. 23, 2026

Related U.S. Application Data
(60) Provisional application No. 63/766,965, filed on Mar. 4, 2025.

(51) Int. Cl. B60T 8/172; B60R 16/033; B60T 7/12; B60T 8/171; B60T 13/74; H02P 3/04

(52) U.S. Cl. CPC B60T 8/172; B60R 16/033; B60T 7/12; B60T 8/171; B60T 13/746; H02P 3/04; B60T 2270/402; B60T 2270/413; B60T 2270/414

(57) ABSTRACT

A brake system for a vehicle is provided, the brake system includes: a first set of brakes installed on a first set of road wheels of the vehicle, the first set of road wheels including two road wheels of the vehicle that are diagonal to one another; a second set of brakes installed on a second set of road wheels of the vehicle, the second set of road wheels including another two road wheels of the vehicle that are diagonal to one another; and a brake controller assembly configured to control the first set of brakes and the second set of brakes, the brake controller assembly including a first backup power source and a second backup power source, which are separate from a vehicle power source of the vehicle.

### CROSS REFERENCE TO RELATED PATENT APPLICATION(S)

This application claims the benefit of U.S. patent application Ser. No. 63/766,965, filed on Mar. 4, 2025, entitled “FOUR WHEEL ELECTROMECHANICAL BRAKE (EMB) VEHICLE ARCHITECTURE”, which is all hereby incorporated by reference in its entirety.

### BACKGROUND

Various embodiments of the present disclosure generally relate to a brake system for a vehicle and more particularly to a vehicle brake system for a four wheel electro-mechanical brake (EMB) architecture.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock, and electric or brake-by-wire brake systems. For example, in a hydraulic brake system, the hydraulic fluid transfers energy from a brake pedal to a brake pad for slowing down or stopping rotation of a wheel of the vehicle. Electronics control the hydraulic fluid in the hydraulic brake system. In an electric brake system, the application and release of the brake is controlled by an electric caliper or motor via an electrical signal.

These electric brake systems typically include an electro-mechanical actuator connected to a brake caliper either by a cable, as the drum in head, or directly attached to the brake caliper. The actuator converts electrical power to rotational mechanical output power for moving the cable or drive screw and applying the brakes. Generally, the electro-mechanical actuator includes an electric motor and a mechanical assembly for achieving the necessary load transfer.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system may comprise: a first set of brakes installed on a first set of road wheels of the vehicle, the first set of road wheels comprising two road wheels of the vehicle that are diagonal to one another; a second set of brakes installed on a second set of road wheels of the vehicle, the second set of road wheels comprising another two road wheels of the vehicle that are diagonal to one another; and a brake controller assembly configured to control the first set of brakes and the second set of brakes, the brake controller assembly comprising a first backup power source and a second backup power source, which are separate from a vehicle power source of the vehicle, wherein the first set of brakes are connected to both the vehicle power source and the first backup power source, and the second set of brakes are connected to both the vehicle power source and the second backup power source.

Each of the first set of brakes and the second set of brakes is an electromechanical brake (EMB), and each of the first backup power source and the second backup power source contains an amount of power that provides at least one full stop for a braking of the vehicle using respective ones of the first set of brakes and the second set of brakes, the at least one full stop comprising setting of at least one parking brake of the respective ones of the first set of brakes and the second set of brakes.

The brake system is compliant with ECE R13H braking specifications, and the vehicle is a level 2 (L2) driving automation vehicle.

The brake controller assembly further comprises a redundant controller architecture comprising a first electronic control unit (ECU) and a second ECU, and the first ECU is connected to the vehicle power source and the first backup power source while the second ECU is connected to the vehicle power source and the second backup power source.

The brake controller assembly may further comprise: a first switching circuit that is configured to switch the first ECU from the vehicle power source to the first backup power source when the first switching circuit detects that the vehicle power source has failed; and a second switching circuit that is configured to switch the second ECU from the vehicle power source to the second backup power source when the second switching circuit detects that the vehicle power source has failed.

Both of the first switching circuit and the second switching circuit are fully analog circuits comprising one or more power transistors.

The one or more power transistors are power Metal-Oxide-Semiconductor Field-Effect Transistors (MOSFETs).

The first switching circuit is further configured to switch the first set of brakes to the first backup power source when the first switching circuit detects that the vehicle power source has failed, and the second switching circuit is further configured to switch the second set of brakes to the second backup power source when the second switching circuit detects that the vehicle power source has failed.

Each of the first backup power source and the second backup power source comprises a super capacitor.

Each of the first backup power source and the second backup power source is a lithium rechargeable battery.

According to various embodiments of the present disclosure, a brake system may comprise: a first set of brakes installed on a first set of road wheels of the vehicle, the first set of road wheels comprising two road wheels of the vehicle that are diagonal to one another; a second set of brakes installed on a second set of road wheels of the vehicle, the second set of road wheels comprising another two road wheels of the vehicle that are diagonal to one another; and a brake controller assembly configured to control the first set of brakes and the second set of brakes, the brake controller assembly comprising a switching circuit that is connected to a first vehicle power source of the vehicle and a second vehicle power source of the vehicle, wherein the first set of brakes is connected to both the first vehicle power source and the second vehicle power source indirectly through the switching circuit, and the second set of brakes is directly connected to the second vehicle power source and indirectly connected to the first vehicle power source through the switching circuit.

Each of the first set of brakes and the second set of brakes is an electromechanical brake (EMB), the first vehicle power source is a first vehicle battery, and the second vehicle power source is a second vehicle battery.

The brake system is compliant with ECE R13H braking specifications, and the vehicle is a level 3 (L3) or level 4 (L4) driving automation vehicle.

The brake controller assembly comprises a redundant controller architecture comprising a first electronic control unit (ECU) and a second ECU, the first ECU being directly connected to the switching circuit and the second ECU being connected directly to the second vehicle battery.

The switching circuit is configured to switch the first ECU and the first set of brakes from being powered by the first vehicle battery to being powered by the second vehicle battery when the switching circuit detects that the first vehicle battery has failed.

The switching circuit is a fully analog circuit comprising one or more power transistors.

The one or more power transistors are power Metal-Oxide-Semiconductor Field-Effect Transistors (MOSFETs).

The second ECU and the second set of brakes are non-operational when the second vehicle battery fails, the second ECU and the second set of brakes being unable to provide any braking operations for the vehicle when non-operational.

A steering system of the vehicle is a steer-by-wire steering system, the brake system is a brake-by-wire brake system, and the brake system comprises a dual controller area network (CAN) support communication system comprising redundant CAN buses.

The brake controller assembly is separate from a chassis controller of the vehicle and is connected to the chassis controller via one or more of the redundant CAN buses of the dual CAN support communication system.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1A is a diagram illustrating a brake system of a vehicle according to an exemplary embodiment of the present disclosure.

FIG. 1B is a diagram illustrating an example brake controller assembly configuration of the brake systems of FIGS. 1A and 1D according to an exemplary embodiment of the present disclosure.

FIG. 1C is an implementation example of the brake system of FIG. 1A according to an exemplary embodiment of the present disclosure.

FIG. 1D is a diagram illustrating a brake system of a vehicle according to an exemplary embodiment of the present disclosure.

FIGS. 1E and 1F are implementation examples of the brake system of FIG. 1D according to an exemplary embodiment of the present disclosure.

FIG. 2 is a diagram illustrating a communication system of the brake systems of FIGS. 1A and 1D according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

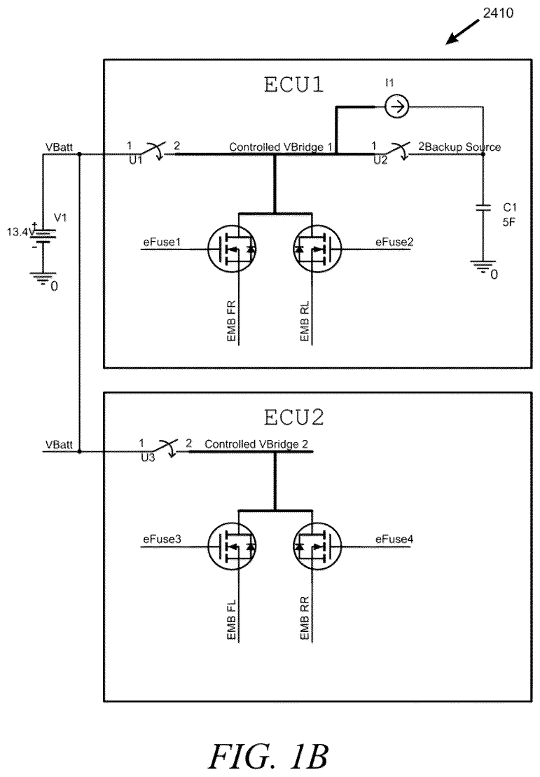

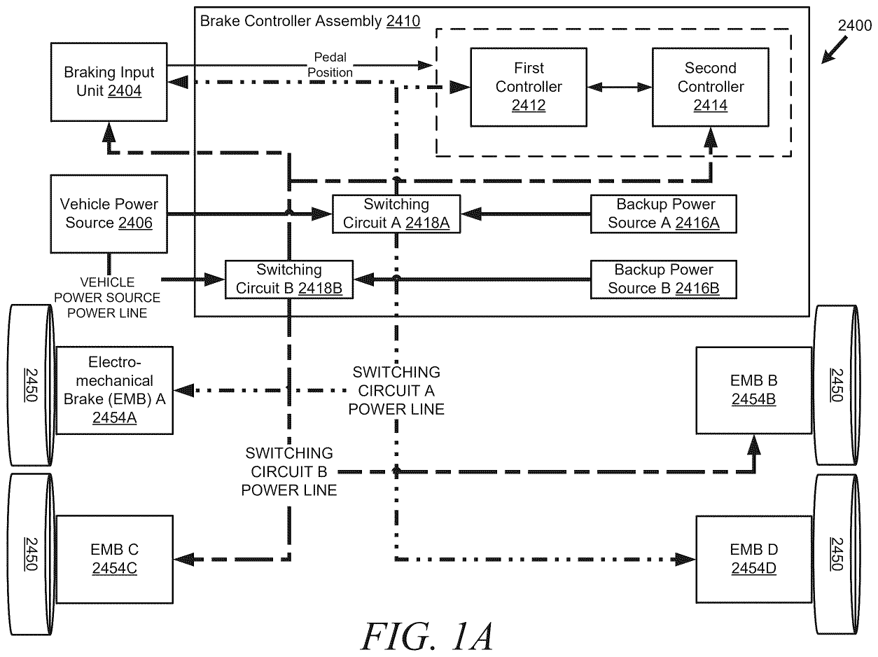

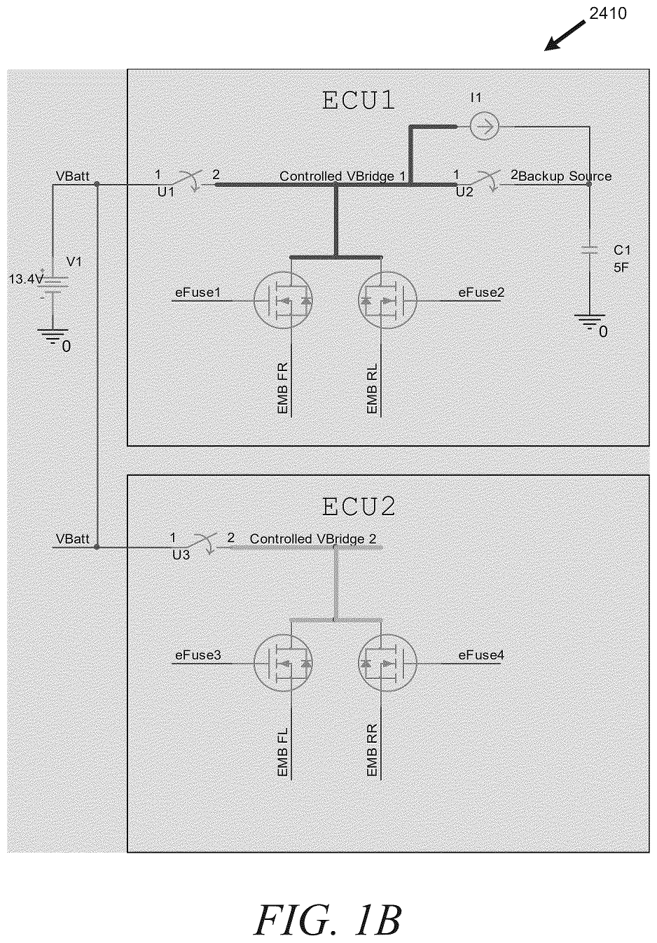

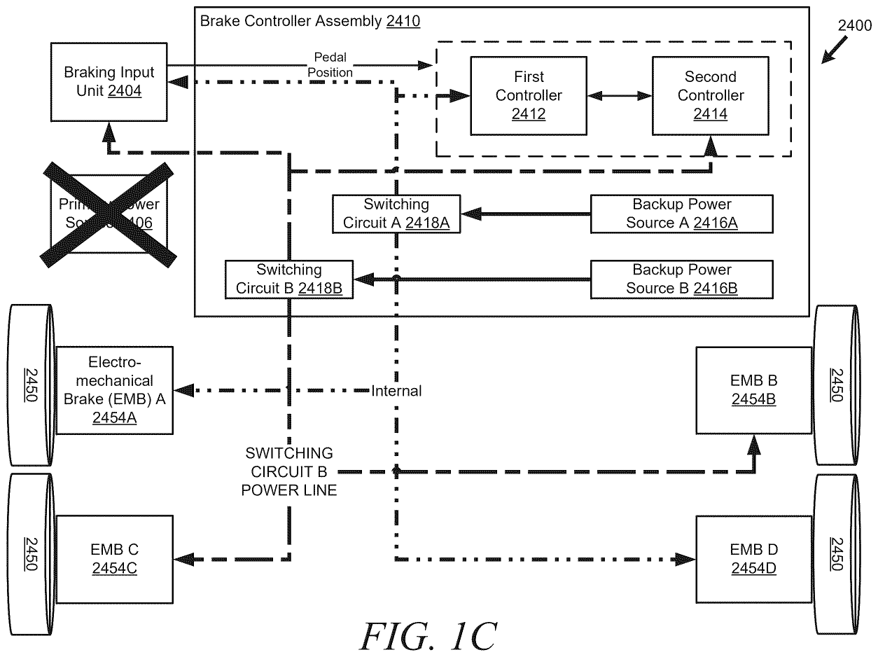

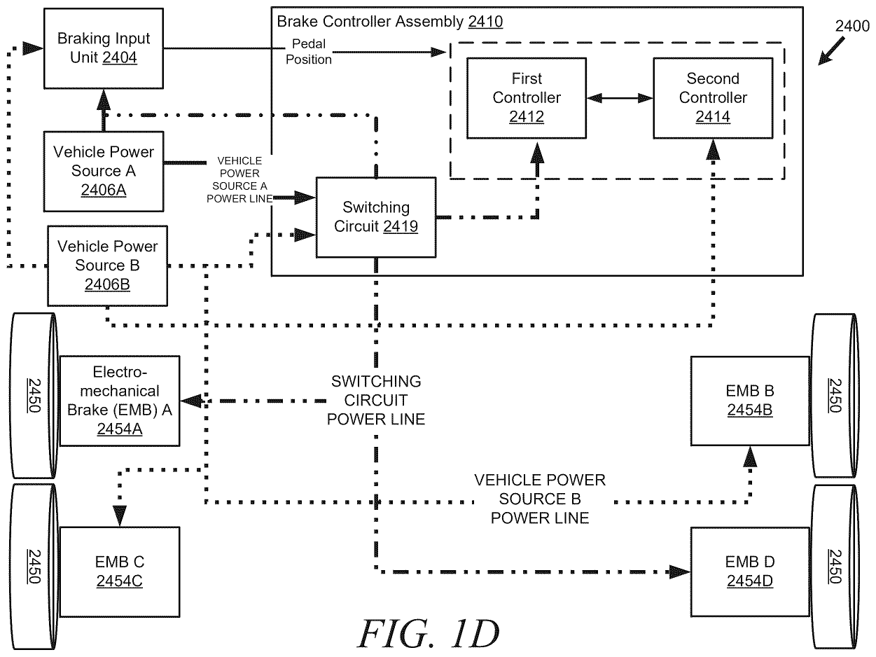

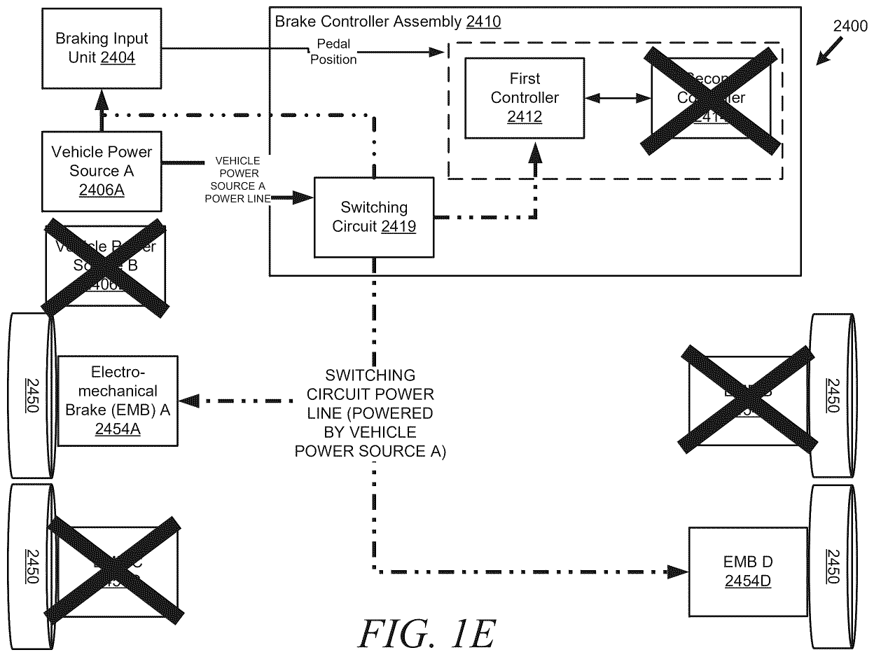

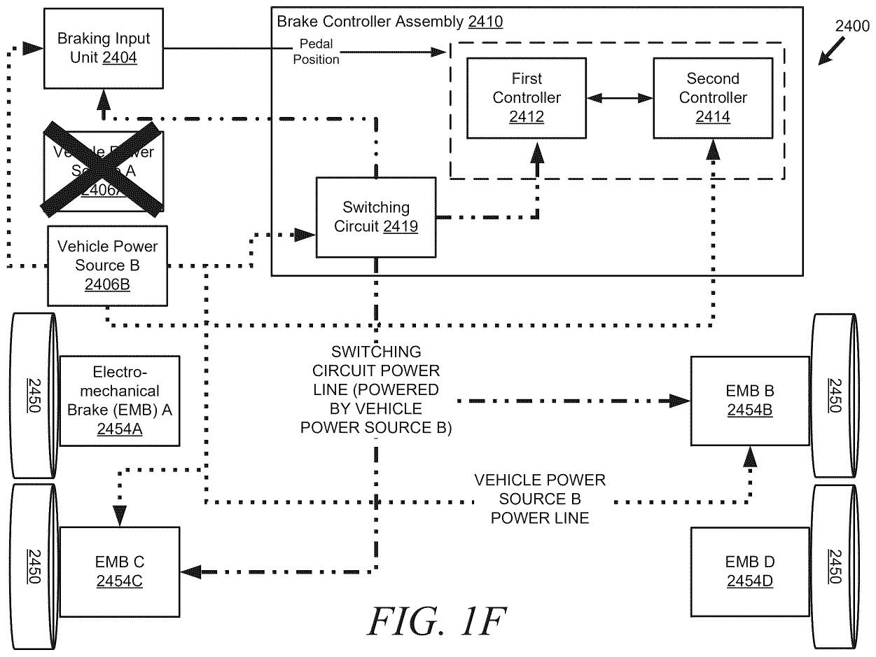

Turning now to FIG. 1A, FIG. 1A shows a brake system 2400 of a vehicle (i.e., a motor vehicle) according to an exemplary embodiment of the present disclosure. In embodiments, the brake system 2400 of FIG. 1A is compatible with any type of steering systems (e.g., steer-by-wire, power steering, rack and pinion steering, recirculating ball steering, hydraulic power steering, electric power steering, manual steering, or the like). In embodiments, the brake system 2400 of FIG. 1A may be configured as a brake-by-wire brake system. In embodiments, the brake system 2400 of FIG. 1A may also be installed in any types of with an internal combustion engine, battery electric, or hybrid power train.

Additionally, the brake system 2400 of FIG. 1A is adapted to meet all of the (i.e., be compliant with) requirements set for a level 2 (L2) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

As shown in FIG. 1A, the vehicle includes four road wheels 2450 (also referred to herein simply as “wheel 2450”). Each of the road wheels is installed with an electromechanical brake (EMB) (i.e., EMBs 2454A-2454D). Each EMB 2454A-2454D may include a parking brake. Alternatively, only the EMBs 2454C and 2454D installed on the rear wheels are provided with parking brakes.

Each EMB may be any type of electro-mechanical brake that utilizes a “brake-by-wire” braking/brake system that uses electric motors at each wheel 2450 to apply braking force, completely replacing hydraulic fluid and mechanical linkages. This advantageously allows for faster response times, independent and precise control of each wheel for improved safety and stability, and a simpler, cleaner design with fewer components. EMBs are considered the future of braking, especially for electric and autonomous vehicles, as they enable more advanced chassis control, regenerative braking, and reduced maintenance.

However, due to the lack of hydraulic fluid and mechanical linkages, EMBs may become completely non-operational (i.e., unable to function and provide any braking capabilities for the vehicle) when power (i.e., electrical power) to the EMBs is lost. For example, should a power source powering the EMBs 2454A-2454D fail, the vehicle will also lose the capability to brake. Thus, a new brake system that can support such full (i.e., four wheel) EMB architecture is needed. Such new brake system not only needs to conform to various braking safety standards (e.g., the ECE R13H braking specifications, or the like) but also needs to prevent adding additional weight and costs (e.g., through addition of a secondary vehicle battery, or the like) to the vehicle as well.

Embodiments disclosed herein (namely, the brake system 2400) are designed to address and resolve the above-discussed problems of such full (i.e., four wheel) EMB architecture, and will be described in more detail as follows.

Turning back to FIG. 1A, the brake system 2400 of embodiments disclosed herein includes a brake controller assembly 2410 made up of a first controller 2412, a second controller 2414, a first switching circuit 2418A (shown in FIG. 1A as “switching circuit A”), a second switching circuit 2418B (shown in FIG. 1A as “switching circuit B”), and at least two backup power sources 2416A and 2416B. Each of the first and second controllers 2412 and 2414 can be configured as, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components.

In one example of embodiments disclosed herein, the first controller 2412 may be configured to act as a primary ECU that controls all of the EMBs 2454A-2454D while the second controller may be configured as a backup (e.g., redundant) ECU that kicks in should the primary ECU fail. Alternatively, in another example of embodiments disclosed herein (discussed in more detail below in reference to FIG. 1B) both of the first controller 2412 and the second controller 2414 may act as primary ECUs and separately control two EMBs 2454A-2454D each.

The two switching circuits 2418A and 2418B may be identical (namely, in operation and/or components). The switching circuits 2418A and 2418B may be configured to detect failure within a vehicle power source 2406 (e.g., a main vehicle battery) of the vehicle in order to switch a connection between components of the brake system 2400 (namely, the components to which each of the two switching circuits 2418A and 2418B are respectively connected to) between the vehicle power source 2406 and one or more backup power sources 2416A and 2416B (shown in FIG. 1A as “backup power source A” and “backup power source B”).

Said another way, when the vehicle power source 2406 is working, the switching circuits 2418A and 2418B connect their respectively connected components of the brake system 2400 with the vehicle power source 2406. And when the vehicle power source 2406 fails, the switching circuits 2418A and 2418B connect their respectively connected components of the brake system 2400 to one of the backup power sources 2416A and 2416B.

More specifically, as shown in FIG. 1A, the first switching circuit 2418A connects at least the braking input unit 2404, the first controller 2412, EMB A 2454A, and EMB D 2454D to a first backup power source 2416A (namely, using switching circuit A power line shown using the dash-dot-dot-dash lines in FIG. 1A). The second switching circuit 2418B, on the other hand, connects at least the braking input unit 2404, the second controller 2414, EMB C 2454C, and EMB B 2454B to a second backup power source 2416B (namely, using switching circuit B power line shown using the long dash-short dash-long dash lines in FIG. 1A).

In short, each switching circuit 2418A and 2418B will connect at least one backup power source (i.e., 2416A, 2416B) to at least the braking input unit 2404, one controller (i.e., 2412 or 2414), and one diagonal set of brakes (i.e., one of the diagonal set of EMBs 2454A and 2454D or the diagonal set of EMBs 2454B and 2454C). This way, the braking input unit 2404 will advantageously still have power (unless the vehicle power source 2406 and the backup power sources 2416A and 2416B all fail, which is highly unlikely) to provide braking inputs to the first controller 2412 and/or the second controller 2414 in order to meet the requirements set for a level 2 (L2) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

In embodiments, each of the switching circuits 2418A and 2418B may be implemented using purely analog components. For example, each of the switching circuits 2418A and 2418B may be configured using a combination of physical switches and transistors (e.g., power Metal-Oxide-Semiconductor Field-Effect Transistors (MOSFETs), bipolar junction transistors (BJTs), or the like). Having each of the switching circuits 2418A and 2418B configured in a purely analog manner advantageously increases a detection and response time of the power failure (of the vehicle power source 2406) as compared to using a digital and analog hybrid (e.g., using microcontrollers to detect and process power levels, current, or the like) configuration.

In embodiments, each of the switching circuits 2418A and 2418B may also be referred to as a “Power OR” circuit (as will be described in more detail below in reference to FIG. 1C). In one example of embodiments disclosed herein, each of the switching circuits 2418A and 2418B may be implemented as part of the respective controller (i.e., the first controller 2412 or the second controller 2414) to which they are connected (e.g., installed on a printed circuit board (PCB), or the like, of the first controller 2412 or the second controller 2414). In another example, each of the switching circuits 2418A and 2418B may be implemented as its own individual component (or combination of components on its own PCB or the like) separate from the other components (i.e., the first controller 2412, the second controller 2414, the backup power sources 2416A and 2416B) of the brake controller assembly 2410.

Each of the backup power sources 2416A and 2416B may be implemented as a super capacitor or as a lithium rechargeable battery. Each of these example components may be charged up (or hold a charge) that is predetermined by a manufacturer of the brake system 2400 (and/or the vehicle) as being necessary for being able to provide one complete full stop (i.e., one complete full brake) of the vehicle while also having enough charge (e.g., electrical power) to set at least one of the parking brakes (also referred to herein as “park brakes”) of the EMBs 2454A-2454D (namely, one of the parking brakes of an EMB installed on a rear wheel of the vehicle).

In one example, assume that a power of at least 200 Joules (J) is required for a 0.4G deceleration for 5 seconds from 70 kilometers per hour to a fully stopped position. Using such conditions while also assuming a capacitor charging capability of 16 volts with a current limited charging circuit, the minimum required capacitance would be 2 farads (F) with a final voltage at 7 volts on the bulk capacitance. Additionally, about 1.8 F would be required for each additional stopping event. Other constraints that are considered here include: a 40 amperage (40 A) peak; enough energy to perform at least one secondary brake apply and EMB parking brake apply maneuver; and a 10+ year lifetime for each of the backup power sources 2416A and 2416B. As a result of such constraints and conditions, if a super capacitor is used as each of the backup power sources 2416A and 2416B, the super capacitor may have the following properties: 6s2p provides 5 F @ 18V rating; 2 F required with a starting voltage of 16V on capacitors; 12 mm d*25 mm h*12 pieces; or the like. If a lithium rechargeable battery is used, the lithium rechargeable battery may have the properties of: 5 mAh battery; or the like. Both the super capacitor and the lithium rechargeable battery may be kept charged using a charging circuit (not shown) that receives power from the primary power source 2406.

In another example, assume that over 7 kJ is required to be used to complete a full braking maneuver using the components of brake controller assembly 2410, in such a situation, the minimum required capacitance may be ~75 F with a final voltage at 7V on the bulk capacitance for capacitors configured to charge up to 16V with a current limited charging circuit. The lithium rechargeable battery selected for such a situation may be a ~500 mAh battery, or the like.

In embodiments, although not shown in FIG. 1A, the brake controller assembly 2410 may include an energy storage health monitor unit and/or circuit (e.g., as part of each of the first controller 2412 and the second controller 2414, separate from both controllers, or the like) that monitors a health and voltage charge of each of the backup power sources 2416A and 2416B (e.g., the super capacitor and/or the lithium rechargeable battery). More specifically, each backup power source 2416A and 2416B may be monitored by the same or separate energy storage health monitor unit and/or circuit(s). This advantageously ensures that the brake controller assembly 2410 (and a vehicle chassis controller or the like that communicates with the brake controller assembly) is always aware of the health and capabilities of each of the backup power sources 2416A and 2416B. For example, should one energy storage health monitor unit and/or circuit detect that one of the backup power sources 2416A or 2416B is no longer holding a charge (or not holding enough of a charge), the brake controller assembly 2410 (and/or the chassis controller of the vehicle) may issue a warning (e.g., to the driver, the manufacturer, or the like) to have that specific backup power source 2416A or 2416B checked on and/or replaced.

In embodiments, the brake system 2400 may also include a braking input unit 2404 and the vehicle power source 2406. As discussed, the vehicle power source 2406 may be the main battery of the vehicle. The braking input unit 2404 may include at least one or more sensors (e.g., a pedal sensor, or the like) that is able to provide vehicle braking operation information (e.g., pedal position, vehicle speed, or the like) to the first and second controllers 2412 and 2414 of the brake controller assembly 2410. The first and second controllers 2412 and 2414 may then use (e.g., process) such vehicle braking operation information in order to operate the EMBs 2454A-2454D.

As additionally shown in FIG. 1A, none of the components of the brake system 2400 are directly connected to (e.g., via vehicle power source power lines shown using a solid black line) and receive power from the vehicle power source 2406. Thus, should the vehicle power source 2406 ever fail, none of the components of the brake system 2400 will be left without a connection to an alternative power source (e.g., the backup power sources 2416A and 2416B) in order to provide braking operations for the vehicle.

In embodiments and as shown in FIG. 1A, the two of the EMBs 2454A-2454D that are connected to each of the backup power sources 2416A and 2416B may be diagonal to one another. Said another way, at least one front EMB (e.g., 2454B as shown in FIG. 1A) and its diagonal rear counterpart (e.g., 2454C as shown in FIG. 1A) will be connected to the second backup power source 2416B (e.g., via the switching circuit B power lines), and the other front EMB (i.e., 2454A) and its diagonal rear counterpart (i.e., 2454D) will be connected to the first backup power source 2416A. This advantageously ensures, when the vehicle power source 2406 and at least one of the backup power source 2416A or 2416B has failed, a secondary brake apply and EMB parking brake apply maneuver that still meets (i.e., conforms to) international braking safety standards (e.g., the ECE R13H braking specifications, or the like) can be provided by at least one of the diagonal pairs of brakes.

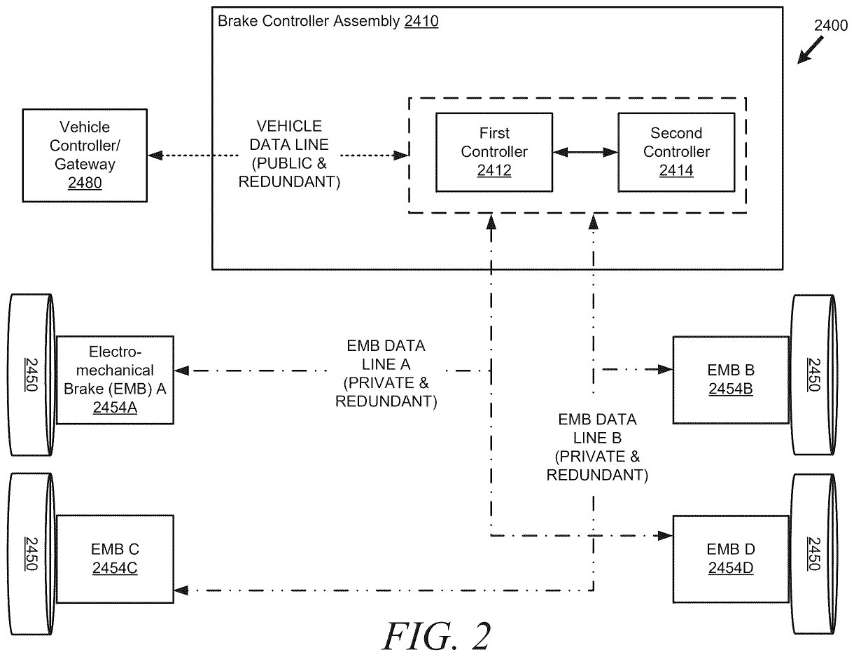

As additionally shown in FIG. 1A, the EMBs 2454A-2454D may be grouped together as diagonal pairs. In particular, EMB A 2454A and EMB D 2454D may be grouped together as one set of brakes while EMB B 2454B and EMB C 2454C may be grouped together as another set of brakes. The EMB A 2454A and EMB D 2454D pair may communicate with each other and the brake controller assembly 2410 using a first data line (i.e., EMB data line A shown in FIG. 2). The EMB B 2454B and EMB C 2454C pair may communicate with each other and the brake controller assembly 2410 using a second data line (i.e., EMB data line B shown in FIG. 2). The communication schema and data lines of the brake system 2400 will be discussed in more detail in reference to FIG. 2.

Turning now to FIG. 1B, FIG. 1B shows is a diagram illustrating an example brake controller assembly configuration of the brake system of FIG. 1A according to an exemplary embodiment of the present disclosure. The example shown in FIG. 1B should not be used to limit embodiments disclosed herein to any one particular configuration and is only presented as one non-limiting example configuration in which the brake controller assembly 2410 can be implemented.

As further shown in the example of FIG. 1B, a switching circuit (e.g., the first switching circuit 2418A, implemented as controlled VBridge 1 and Controlled VBridge 2 in FIG. 1B) may prevent complete loss of braking by allowing at least ECU 1 to be reconnected to (i.e., switched to) a backup source (i.e., the first backup power source 2416A) from VBatt (i.e., the vehicle power source 2406). In particular, the first switching circuit 2418A may be implemented using a combination of power MOSFETs, which are used to connect (e.g., in a logical OR connection matter) the two power sources (i.e., VBatt and Backup Source) to one another. Upon loss of VBatt, switch U1 will open while switch U2 will close, connecting the Backup Source to the two EMBs connected to and controlled by ECU 1. In this example, switch U2 will remain closed during standard operation (i.e., when VBatt has not failed) and only be turned on when VBatt has failed. Drivers for the switches (e.g., U1, U2, U3) may also contain reverse battery and/or over-temperature protection mechanisms.

Turning now to FIG. 1C, FIG. 1C is an implementation example of the brake system of FIG. 1A according to an exemplary embodiment of the present disclosure. More specifically, FIG. 1C shows a state where the vehicle power source 2406 has failed, as marked by a X over the diagram for vehicle power source 2406.

In such a state where the vehicle power source 2406 has failed, the two switching circuits 2418A and 2418B detect this failure and switch to connecting their respective connected components to the backup power sources 2416A and 2416B. As a result, all of the components of braking system 2400 will remain powered by at least one of the two backup power sources 2416A and 2416B, to which they are respectively connected. Said another way, none of the components of braking system 2400 will fully lose power become fully non-operational (i.e., fully incapable of providing any functions and/or capabilities these components were designed to provide).

As further shown in FIG. 1C, upon failure of vehicle power source 2406, the first switching circuit 2418A will switch the braking input unit 2404, the first controller 2412, EMB A 2454A, and EMB D 2454D to receive power instead from the first backup power source 2416A while the second switching circuit 2418B will switch the braking input unit 2404, the second controller 2414, EMB B 2454B, and EMB C 2454C to receive power instead from the second backup power source 2416B.

As a result of such switching to the backup power sources 2416A and 2416B, these backup power powered up components are able to work together (i.e., in tandem) to provide at least one secondary brake apply and EMB parking brake apply maneuver (or as many of secondary brake apply and EMB parking brake apply maneuvers as the power stored/charged up in each of the backup power sources 2416A and 2416B permits) to safely bring the vehicle to a full (i.e., complete stop) using the charge (i.e., electrical charge) stored in each of the backup power sources 2416A and 2416B.

Such a configuration shown in the implementation example of FIG. 1C not only advantageously conforms the brake system 2400 to international braking safety standards (e.g., the ECE R13H braking specifications, or the like) and the requirements set for a level 2 (L2) driving automation vehicle as defined under Society of Automotive Engineers (SAE) J 3016 “Taxonomy and Definitions for Terms Related to Driving Automation Systems for On-Road Motor Vehicles” definitions, standards, and/or requirements, but also effectively reduces the cost and complexity of the brake system 2400 by not requiring another vehicle battery to be separately installed as a backup battery to the vehicle power source 2406. Thus, the above-discussed problems associated with using a full (i.e., all four-wheel) EMB architecture are resolved, and a new and improved brake system is obtained.

Turning now to FIG. 1D, FIG. 1D shows another example of the brake system 2400 of a vehicle (i.e., a motor vehicle) according to an exemplary embodiment of the present disclosure. In the example shown in FIG. 1D, the brake system 2400 of embodiments herein may have all of the same components as the brake system 2400 of FIG. 1A except for the backup power sources 2416A and 2416B (that are internally installed/provided within the brake controller assembly 2410) and the two switching circuits 2418A and 2418B shown in FIG. 1A). More specifically, instead of having the backup power sources 2416A and 2416B that are built into (i.e., provided as part of) the brake controller assembly 2410, the example brake system 2400 of FIG. 1B includes a second vehicle power source 2406B (i.e., a second vehicle battery, and shown in FIG. 1D as “vehicle power source B”). The second vehicle power source 2406B may separate from and be disposed (i.e., positioned, installed, etc.) external to the brake controller assembly 2410, and may be configured to be a backup battery of the vehicle (i.e., a secondary battery to the first vehicle power source 2406A, which is now configured as a primary vehicle battery of the vehicle). Said another way, the vehicle in which brake system 2400 of FIG. 1D is installed has two vehicle batteries.

In embodiments, the example brake system 2400 of FIG. 1D is adapted to meet all of the requirements set for a level 3 (L3) and/or level 4 (L4) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

In embodiments, the two vehicle power sources 2406A and 2406B may have the same rating (i.e., be the same rated batteries). Alternatively, the second vehicle power source 2406B (i.e., the secondary/backup vehicle battery) may have a lower battery rating than the first vehicle power source 2406A (i.e., the primary vehicle battery). Both (or at least one of the) vehicle power sources 2406A and 2406B may be rated to provide enough power to fully control all four EMBs (i.e., EMBs 2454A through 2454D), or may be rated to provide enough power to only fully control two of the four EMBs.

As further shown in FIG. 1D, the brake controller assembly 2410 only includes one switching circuit 2419. In embodiments, switching circuit 2419 may be identical in configuration and operation as any of the switching circuits 2418A and 2418B discussed in reference to FIG. 1A. Said another way, switching circuit 2419 may be a single Power OR circuit that is embedded (e.g., provided in) brake controller assembly 2410 (e.g., as part of first controller 2412 or as a completely separate component from both the first controller 2412 and the second controller 2414).

As further shown in FIG. 1D, the first vehicle power source 2406A provides power to one or more components of brake system 2400 using “vehicle power source A power line” (shown using solid arrowed lines in FIG. 1D) while the second vehicle power source 2406B provides power to one or more components of brake system 2400 using “vehicle power source B power line” (shown using the broken arrowed (namely, the dot-dot-dot-dot) lines in FIG. 1D).

In embodiments, both vehicle power sources 2406A and 2406B are connected to switching circuit 2419. Switching circuit 2419 in turn is connected to at least the braking input unit 2404, the first controller 2412 (or whichever of the two controllers is configured as the main/master controller of brake controller assembly 2410), and at least one set of the diagonal brakes (namely, EMB A 2454A and EMB D 2454D as shown in the example of FIG. 1D), and provides power to these components (through whichever of the two vehicle power sources 2406A or 2406B the switching circuit 2419 is actively letting power through) using “switching circuit power line” (shown using the dash-dot-dot-dash arrowed lines in FIG. 1D).

As further shown in FIG. 1D, the second vehicle power source 2406B is also directly connected to and powers at least the second controller 2414, the braking input unit 2404, and the other set of diagonal brakes (namely, EMB B 2454B and EMB C 2454C). As a result, as long as one of the two vehicle power sources 2406A and 2406B has not failed, the braking input unit 2404 will always have power to provide braking inputs to the brake controller assembly 2410 in order to operate one or more of the EMBs (i.e., 2454A-2454D).

Additionally, as discussed in more detail in reference to FIGS. 1E and 1F, there will always be at least two EMBs (from among EMBs 2454A-2454D) that will be operational to provide at least one at least one secondary brake apply and EMB parking brake apply maneuver should any of the two vehicle power sources 2406A and 2406B fail, which is required to meet the requirements set for a level 3 (L3) and/or level 4 (L4) driving automation vehicle as defined under Society of Automotive Engineers (SAE) J 3016 “Taxonomy and Definitions for Terms Related to Driving Automation Systems for On-Road Motor Vehicles” definitions, standards, and/or requirements.

Turning now to FIG. 1E, FIG. 1E is an implementation example of the brake system of FIG. 1D according to an exemplary embodiment of the present disclosure.

As shown in FIG. 1E, the second vehicle power source 2406B has failed. As a result, the second controller 2414, EMB B 2454B, EMB C 2454C lose power and are fully non-operational (i.e., completely unable to be used to provide any braking operations for the vehicle, as long as second vehicle power source 2406B remains as being in a failed state). The first controller 2412, through one or more signals provided from the switching circuit 2419 learns of the failure of the second vehicle power source 2406B, and switches an internal braking algorithm being applied by the first controller 2412 to switch from braking using all four EMBs (i.e., all four EMBs 2454A-2454D) to braking using only the two remaining EMBs (i.e., EMB A 2454A and EMB D 2454D) that continue to receive power from the first vehicle power source 2406A through switching circuit 2419. The first controller 2412 will also cause the brake system 2400 to go into a safety mode and report the entry of the safety mode to a central controller (e.g., a chassis controller or the like as shown in reference to FIG. 2) of the vehicle.

Turning now to FIG. 1F, FIG. 1F is an implementation example of the brake system of FIG. 1D according to an exemplary embodiment of the present disclosure.

As shown in FIG. 1F, the first vehicle power source 2406A has not failed while the second vehicle power source 2406B is still operational (i.e., has not failed). Upon detection of the failure of the first vehicle power source 2406A, the switching circuit 2419 will switch to providing power to the components connected using the switching circuit power lines using power received from the second vehicle power source 2406B. As a result, all four EMBs (i.e., 2454A-2454D) may remain operational to provide at least one secondary brake apply and EMB parking brake apply maneuver to safely bring the vehicle to a full stop.

In embodiments, depending on how the second vehicle power source 2406B is rated, all or some of the four EMBs (i.e., 2454A-2454D) may be used by brake system 2400 to provide the at least one secondary brake apply and EMB parking brake apply maneuver to safely bring the vehicle to a full stop.

For example, assume that the second vehicle power source 2406B is rated to be able to provide enough power to power all four EMBs (i.e., 2454A-2454D) (along with all the other remaining components of brake system 2400), the first controller 2412 may work in tandem with the second controller 2414 to use all four EMBs (i.e., 2454A-2454D) to provide the at least one secondary brake apply and EMB parking brake apply maneuver to safely bring the vehicle to a full stop.

As another example, assume that the second vehicle power source 2406B is rated to be able to provide enough power to power only two of the four EMBs (i.e., 2454A-2454D) (along with all the other remaining components of brake system 2400), the first controller 2412 may work in tandem with the second controller 2414 to either: (i) use all four EMBs (i.e., 2454A-2454D) to provide the at least one secondary brake apply and EMB parking brake apply maneuver to safely bring the vehicle to a full stop but at a reduced power capacity at all of the four EMBs (e.g., all four EMBs providing braking but at a reduced braking power rate (e.g., half of the normal braking power each EMB is capable of providing) and only one of the two rear EMBs applying the electrical parking brake, or the like); (ii) select at least one diagonal EMB pair among the two diagonal pair to be operated at full power (i.e., to provide full braking power that each of the two EMBs are capable of providing) to provide the at least one secondary brake apply and EMB parking brake apply maneuver.

As a result of the implementation examples of FIGS. 1E and 1F, as long as one of the two vehicle power sources 2406A and 2406B remain operational (i.e., has not failed), the braking system 2400 will advantageously be able to use at least two of the EMBs (i.e., at least two of EMBs 2454A-2454D) to safely provide at least one secondary brake apply and EMB parking brake apply maneuver to safely bring the vehicle to a full stop. Such redundancy and fail-safe process also advantageously meets not only the international braking safety standards (e.g., the ECE R13H braking specifications, or the like) but also the requirements set for a level 3 (L3) and/or level 4 (L4) driving automation vehicle as defined under Society of Automotive Engineers (SAE) J 3016 “Taxonomy and Definitions for Terms Related to Driving Automation Systems for On-Road Motor Vehicles” definitions, standards, and/or requirements using a vehicle that is provided with EMBs at all four corners (i.e., all four wheels) of the vehicle (i.e., using a vehicle where there are alternative no push through mechanisms such as hydraulic systems/mechanisms available to force a braking operation using the EMBs should one or more of the EMBs lose power).

FIG. 2 is a diagram illustrating a communication system of the brake systems of FIGS. 1A and 1D according to an exemplary embodiment of the present disclosure.

As shown in FIG. 2, the vehicle may include a vehicle controller/gateway 2480 (e.g., associated to the main/chassis controller of the vehicle) that may be in communication (e.g., via vehicle data line shown in FIG. 2) with the brake controller assembly 2410 (namely, with each of the first controller 2412 and/or the second controller 2414). All of the EMBs 2454A-2454D may also be in communication (e.g., via EMB data line A and EMB data line B shown in FIG. 2) with the brake controller assembly 2410 (namely, with each of the first controller 2412 and/or the second controller 2414).

In embodiments, each of the vehicle data line and the EMB data lines A and B may be configured using controller area network (CAN) bus/channels (and/or the Ethernet). The vehicle data line(s) may be configured using public CAN(s) while the EMB data lines A and B may be configured using private CAN(s). Each of the vehicle data line and the EMB data lines A and B may also be redundant. More specifically, there may be two separate public CAN vehicle data lines; one connecting the vehicle controller/gateway 2480 to the first controller 2412 and the other separately connecting the vehicle controller/gateway 2480 to the second controller 2414. Similarly, there may be two separate sets of private CAN EMB data line A; one set connecting EMBs 2454A and 2454D to the first controller 2412 and the other set separately connecting EMBs 2454A and 2454D to the second controller 2414. There may also be two separate sets of private CAN EMB data line B; one set connecting EMBs 2454B and 2454C to the first controller 2412 and the other set separately connecting EMBs 2454B and 2454C to the second controller 2414.

Such a configuration in FIG. 2 forms a dual controller area network (CAN) support communication system comprising redundant CAN buses for the brake system 2400. As a result, upon failure of one of the two controllers 2412 or 2414 (e.g., when second controller 2414 loses power, or the like), the first controller 2412 can still separately and individually maintain CAN functions with all of the EMBs 2454A-2454D and/or with the vehicle controller/gateway 2480 (which may have its own redundant/backup power source separate from any of the backup power sources used for the brake system 2400).

Although the example embodiments have been described in detail, it should be understood that various changes, substitutions and alterations can be made herein without departing from the spirit and scope of the application as defined by the appended claims.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A brake system for a vehicle, the brake system comprising:
a first set of brakes installed on a first set of road wheels of the vehicle, the first set of road wheels comprising two road wheels of the vehicle that are diagonal to one another;
a second set of brakes installed on a second set of road wheels of the vehicle, the second set of road wheels comprising another two road wheels of the vehicle that are diagonal to one another; and
a brake controller assembly configured to control the first set of brakes and the second set of brakes, the brake controller assembly comprising a first backup power source and a second backup power source, which are separate from a vehicle power source of the vehicle,
wherein the first set of brakes is connected to both the vehicle power source and the first backup power source, and the second set of brakes is connected to both the vehicle power source and the second backup power source.

2. The brake system of claim 1, wherein
each of the first set of brakes and the second set of brakes is an electromechanical brake (EMB), and
each of the first backup power source and the second backup power source contains an amount of power that provides at least one full stop for a braking of the vehicle using respective ones of the first set of brakes and the second set of brakes, the at least one full stop comprising setting of at least one parking brake of the respective ones of the first set of brakes and the second set of brakes.

3. The brake system of claim 2, wherein the brake system is compliant with ECE R13H braking specifications, and the vehicle is a level 2 (L2) driving automation vehicle.

4. The brake system of claim 3, wherein
the brake controller assembly further comprises a redundant controller architecture comprising a first electronic control unit (ECU) and a second ECU, and
the first ECU is connected to the vehicle power source and the first backup power source while the second ECU is connected to the vehicle power source and the second backup power source.

5. The brake system of claim 4, wherein the brake controller assembly further comprises:
a first switching circuit that is configured to switch the first ECU from the vehicle power source to the first backup power source when the first switching circuit detects that the vehicle power source has failed; and
a second switching circuit that is configured to switch the second ECU from the vehicle power source to the second backup power source when the second switching circuit detects that the vehicle power source has failed.

6. The brake system of claim 5, wherein both of the first switching circuit and the second switching circuit are fully analog circuits comprising one or more power transistors.

7. The brake system of claim 6, wherein the one or more power transistors are power Metal-Oxide-Semiconductor Field-Effect Transistors (MOSFETs).

8. The brake system of claim 5, wherein
the first switching circuit is further configured to switch the first set of brakes to the first backup power source when the first switching circuit detects that the vehicle power source has failed, and
the second switching circuit is further configured to switch the second set of brakes to the second backup power source when the second switching circuit detects that the vehicle power source has failed.

9. The brake system of claim 8, wherein each of the first backup power source and the second backup power source comprises a super capacitor.

10. The brake system of claim 8, wherein each of the first backup power source and the second backup power source is a lithium rechargeable battery.

11. A brake system for a vehicle, the brake system comprising:
a first set of brakes installed on a first set of road wheels of the vehicle, the first set of road wheels comprising two road wheels of the vehicle that are diagonal to one another;
a second set of brakes installed on a second set of road wheels of the vehicle, the second set of road wheels comprising another two road wheels of the vehicle that are diagonal to one another; and
a brake controller assembly configured to control the first set of brakes and the second set of brakes, the brake controller assembly comprising a switching circuit that is connected to a first vehicle power source of the vehicle and a second vehicle power source of the vehicle, wherein
the first set of brakes is connected to both the first vehicle power source and the second vehicle power source indirectly through the switching circuit, and
the second set of brakes is directly connected to the second vehicle power source and indirectly connected to the first vehicle power source through the switching circuit.

12. The brake system of claim 11, wherein, each of the first set of brakes and the second set of brakes is an electromechanical brake (EMB), the first vehicle power source is a first vehicle battery, and the second vehicle power source is a second vehicle battery.

13. The brake system of claim 12, wherein the brake system is compliant with ECE R13H braking specifications, and the vehicle is a level 3 (L3) or level 4 (L4) driving automation vehicle.

14. The brake system of claim 13, wherein the brake controller assembly comprises a redundant controller architecture comprising a first electronic control unit (ECU) and a second ECU, the first ECU being directly connected to the switching circuit and the second ECU being connected directly to the second vehicle battery.

15. The brake system of claim 14, wherein the switching circuit is configured to switch the first ECU and the first set of brakes from being powered by the first vehicle battery to being powered by the second vehicle battery when the switching circuit detects that the first vehicle battery has failed.

16. The brake system of claim 15, wherein the switching circuit is a fully analog circuit comprising one or more power transistors.

17. The brake system of claim 16, wherein the one or more power transistors are power Metal-Oxide-Semiconductor Field-Effect Transistors (MOSFETs).

18. The brake system of claim 15, wherein the second ECU and the second set of brakes are non-operational when the second vehicle battery fails, the second ECU and the second set of brakes being unable to provide any braking operations for the vehicle when non-operational.

19. The brake system of claim 12, wherein a steering system of the vehicle is a steer-by-wire steering system, the brake system is a brake-by-wire brake system, and the brake system comprises a dual controller area network (CAN) support communication system comprising redundant CAN buses.

20. The brake system of claim 19, wherein the brake controller assembly is separate from a chassis controller of the vehicle and is connected to the chassis controller via one or more of the redundant CAN buses of the dual CAN support communication system.
